(19) United States
(12) Patent Application Publication
(10) Pub. No.: US 2025/0193669 A1
(43) Pub. Date: Jun. 12, 2025

(54) Restoring Loss Passcodes/Passwords Using a Connected Trusted Device

(71) Applicant: QUALCOMM Incorporated, San Diego, CA (US)

(72) Inventors: Gopinath S, Chennai (IN); Venkatesha M IYENGAR, Bengaluru (IN); Sai Jitendra Varma GADIRAJU, Hyderabad (IN); Sai Naresh GAJAPAKA, Hyderabad (IN)

(21) Appl. No.: 18/532,383

(22) Filed: Dec. 7, 2023

(51) Int. Cl. H04W 12/06; H04W 12/50

(52) U.S. Cl. CPC H04W 12/068; H04W 12/50

(57) ABSTRACT

Various embodiments enable restoring a lost passcode on a computing device using a connected trusted device. The computing device may generate a passcode reset request to the trusted device, display the first generated codeword on the electronic device, receive the first displayed codeword into the trusted device, receive a passcode reset response from the trusted device using a network, transmit an authentication success message to the trusted device in response to the first generated codeword matching the first received codeword, generate a second codeword by the trusted device, display the second generated codeword on the trusted device, receive the second displayed codeword into the electronic device, transmit a passcode reset confirmation to the trusted device using the network, transmit an authentication pairing success message to the electronic device in response to the second generated codeword matching the received second codeword, and reset the passcode on the electronic device.

### BACKGROUND

Passwords and passcodes: can't live with them; can't live without them. Having strong PIN/passcodes and using different PINs/passcodes for different accounts and different devices is crucial to avoid becoming a victim to hacking. But this requirement can be a real headache for users who own multiple smart devices all working on the same network, such as a home Wi-Fi network because it can be difficult to remember several different strong passwords. Thus, users frequently forget PIN/passcodes and must resort to a forgotten PIN/passcode device recovery procedure. For example, users may use a Google or Apple account recovery procedure. However, to protect users against hackers, these PIN/passcode/password recovery procedures are necessarily complex and require the computing device to have Internet connectivity. And if such methods fail, the only recovery option is to do a factory data resent, which is undesirable because all data stored on the computing device will be erased.

### SUMMARY

Systems, methods, and devices of various aspects enable a first computing device to restore a lost passcode to the first computing device using a second computing device that is a companion trusted device.

In various aspects, a first computing device may perform operations including transmitting a passcode reset request to the second computing device via the wireless network, the passcode reset request including a first generated codeword, displaying the first generated codeword on the first computing device, receiving a passcode reset response from the second computing device via the wireless network, the passcode reset response including a first received codeword, determining whether the first generated codeword matches the first received codeword included in the passcode reset response, transmitting an authentication success message to the second computing device via the wireless network in response to the first generated codeword matching the first received codeword, receiving a user input of a second received codeword in the first computing device, transmitting a passcode reset confirmation to the second computing device via the wireless network, the passcode reset confirmation including the second received codeword, receiving an authentication pairing success message from the second computing device, and resetting the passcode on the first computing device in response to receiving the authentication pairing success message from the second computing device.

Some aspects may further include configuring the first computing device to communicate via the wireless network; and connecting the first computing device to the wireless network. Some aspects may further include receiving configuration data regarding the wireless network by the computing device, identifying the wireless network using the configuration data, identifying the second computing device using the configuration data, connecting to the wireless network, and communicating with the second computing device for pairing.

In some aspects, resetting the passcode on the first computing device may include displaying successful pairing on a display of the computing device, receiving a first copy of a new passcode, receiving a second copy of the new passcode, determining whether the first copy of the new passcode matches the second copy of the new passcode, and saving the new passcode on the computing device in response to the first copy of the new passcode matching the second copy of the new passcode.

Some aspects may further include generating a random number and using the generated random number in the first generated codeword.

In some aspects, the computing device may be one of a smartphone, a smartwatch, a tablet device, a desktop computer, or a laptop computer.

In some aspects, the wireless network may be a direct device-to-device mesh network that the first computing device automatically joins in response to detecting the wireless direct device-to-device mesh network. In some aspects, the wireless network may include one of a Wi-Fi network, a ZigBEE network, or a Bluetooth network.

Further aspects may include methods performed by a second computing device for restoring a lost passcode on a first computing device. Various aspects may include receiving a passcode reset request from the first computing device, the passcode reset request including a first generated codeword, displaying the first generated codeword on a display of the second computing device, receiving a user input by the second computing device of a first received codeword, transmitting to the first computing device a passcode reset response via a wireless network, the passcode reset response including the first received codeword, receiving an authentication success message from the first computing device, generating a second codeword in response to receiving the authentication success message from the first computing device, displaying the second generated codeword on a display of the second computing device, receiving a passcode reset confirmation from the first computing device via the wireless network, the passcode reset confirmation including a second received codeword, determining whether the second generated codeword matches the second received codeword included in the passcode reset confirmation, and transmitting an authentication pairing success message to the first computing device in response to determining that the second generated codeword matches the second received codeword included in the passcode reset confirmation.

Some aspects may further include configuring the second computing device, and connecting the second computing device to the wireless network. In some aspects, configuring the second computing device may include receiving configuration data by the second computing device, identifying the wireless network using the configuration data, identifying the first computing device using the configuration data, connecting to the wireless network, and communicating with the first computing device for pairing.

Some aspects may further include generating a random number and using the generated random number in the second generated codeword. In some aspects, the second computing device may be one of a smartphone, a smartwatch, a tablet device, a desktop computer, or a laptop computer.

In some aspects, the wireless network may be a direct device-to-device mesh network in which the computing device automatically joins the direct device-to-device mesh network in response to detecting the direct device-to-device mesh network. In some aspects, the wireless network may be one of a Wi-Fi network, a ZigBEE network, or a Bluetooth network.

Various aspects include a mobile or wearable computing device including a processor configured with processor-executable instructions to perform operations of the embodiment methods described above. Various aspects also include a non-transitory processor-readable storage medium having stored thereon processor-executable software instructions configured to cause a processor to perform operations of the embodiment methods described above. Various aspects also include a mobile or wearable communication device that includes means for performing functions of the operations of the embodiment methods described above.

### BRIEF DESCRIPTION OF THE DRAWINGS

The accompanying drawings, which are incorporated herein and constitute part of this specification, illustrate example embodiments. Together with the general description given above and the detailed description given below, serve to explain the features of the various embodiments.

FIG. 1 is a communication system block diagram of mobile communications network suitable for use with various implementations.

FIG. 2 is a functional block diagram of a computing device suitable for implementing various implementations.

FIG. 3 illustrates a component block diagram illustrating a system configured for restoring a lost passcode using a trusted device in accordance with various embodiments.

FIG. 4 is a system block diagram illustrating an embodiment of restoring a lost passcode on a first computing device using a second computing device in accordance with various embodiments.

FIG. 5 is a message flow diagram illustrating an embodiment of restoring a lost passcode on a first computing device using a second computing device of in accordance with various embodiments.

FIGS. 6A-B is a process flow diagram illustrating a method for restoring a lost passcode to a first computing device using a second computing device in accordance with various embodiments.

FIG. 7 is a process flow diagram illustrating a method for restoring a lost passcode to a first computing device using a companion trusted device in accordance with some embodiments.

FIG. 8 is a process flow diagram illustrating a method for restoring a lost passcode to a first computing device using a second computing device in accordance with some embodiments.

FIG. 9 is a process flow diagram illustrating a method for restoring a lost passcode to a first computing device using a second computing device in accordance with some embodiments.

FIG. 10 is a component diagram of a mobile computing device including a smartphone suitable for use with the various embodiments.

FIG. 11 is a component diagram of a computing device including a laptop computer suitable for use with the various embodiments.

FIG. 12 is a component diagram of a computing device including a small touchscreen suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the various embodiments or the claims.

As used herein, the term “computing device” is used herein to refer to any one or all of smart watches, wearable computers (e.g., computing devices in the form of a badge, tag, bracelet, patch, belt buckle, medallion, necklace, pendant, pen, key chain, or any other device worn or carried by a user), cellular telephones, smart phones, personal or mobile multi-media players, personal data assistants (PDAs), wireless electronic mail receivers, multimedia Internet enabled cellular telephones, wireless gaming controllers, and similar personal electronic devices that include one or more programmable processor, memory, and a touchscreen display or similar user interface for displaying characters and/or images and receiving user inputs. A computing device may also include a computing device with a small display that may be attached to or integrated with a small area of an appliance, furniture, on a small area of a vehicles (e.g., on motorcycles, bicycles, or cars), and on small hand-held computing devices such as tablets and smart phones.

The term “wireless device” is used herein to refer to any one or all of wireless router devices, wireless appliances, cellular telephones, smartphones, portable computing devices, personal or mobile multi-media players, laptop computers, tablet computers, smart books, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

Various embodiments include methods enabling users to recover use of a computing device (“first device”) that is connected to a direct device-to-device mesh network for which the user has forgotten the passcode by using another of the user's direct device-to-device mesh network-connected computing devices (“second device”) that has been pre-configured to provide this service using direct device-to-device communications without engaging or connecting via the Internet. Various embodiments provide a method of transferring one-time passcodes from a connected pre-configured companion computing device via device-to-device communications and using exchanges of the one-time pin/passcodes to enable changing (i.e., replacing) the forgotten passcode and recovering full use of the first smart device.

Some embodiments may make use of a direct device-to-device mesh network using a communication protocol that provides a medium access control (MAC) technique of the IEEE 802.11-based WLAN standard (including Wi-Fi). A direct device-to-device mesh network may support direct device-to-device communications using Wi-Fi or BLUETOOTH® as the wireless protocol. However, other device-to-device communication techniques and/or protocols that provide the same or similar capability may be used to implement various embodiments. In particular, direct mode communications that are supported in 3GPP LTE protocols via Sidelink (SL) may be used in some embodiments.

In some embodiments, both the first and second computing devices are pre-configured with software to perform the methods. There are two methods-one method performed on the computing device that is being recovered (first computing device), and another method performed on the computing device that enables the recovery processes (second computing device). In some embodiments, either one or both methods may be combined in a single application that may be loaded into all user computing devices that may connect with the direct device-to-device network.

For the purpose of describing various embodiments, the use of the term “passcode” is intended to include passwords, passcodes, PINs, and similar alpha-numeric and numeric codes input by a user to gain access to a computing device. Use of these terms in any description herein is intended to include any alpha-numeric code capable of input by a user.

The operations of various embodiments involve the following. When a user forgets the passcode for a pre-configured first device, the user may press/select a “forgot passcode” option on the first device user interface (e.g., instead of entering a passcode). The first computing device then may notify a pre-configured second (companion trusted) device in a device-to-device mesh network to initiate a computing device recovery procedure. In response, the second device may signal the first device to display a randomly generated pairing passcode. The user may authenticate the pairing request by entering the pairing passcode displayed on the first device into the second computing device that is a companion trusted device. The second computing device may send the entered pairing passcode to the first device, which confirms that the received passcode is correct, and if so, may acknowledge or confirm the received information to the second device.

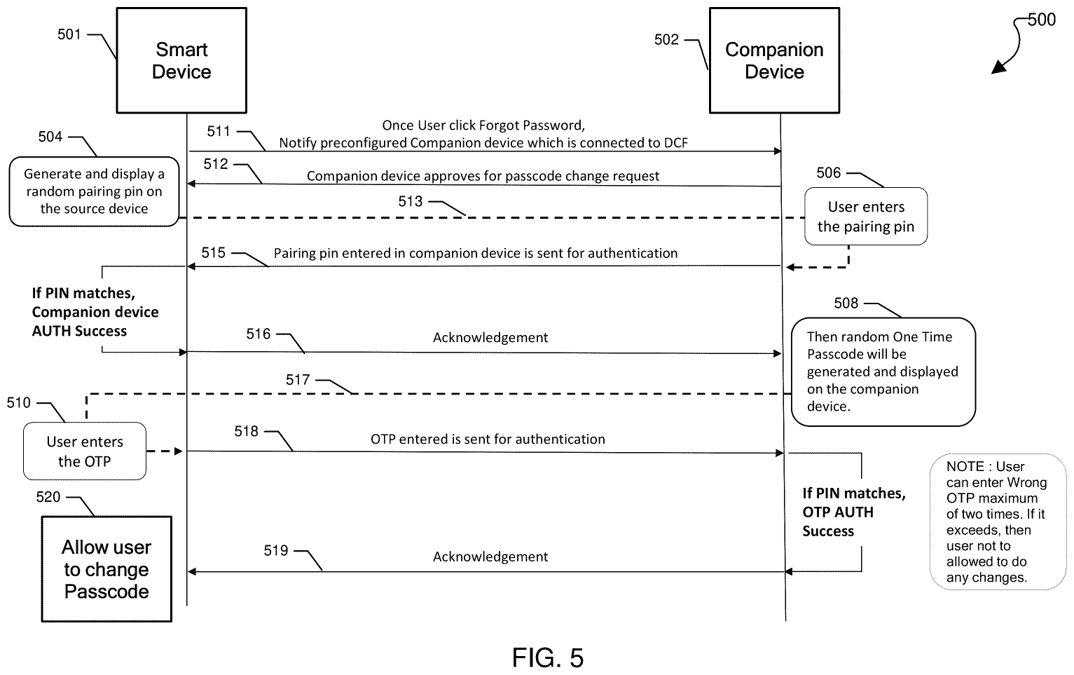

In response to the first computing device notifying the second computing device that the received random passcode is correct, the second computing device may generate a random one-time passcode that it displays for the user. The user then may enter that one-time passcode such that it is received by the first computing device. The first computing device may send the received one-time passcode to the second computing device for validation. The second computing device may authenticate that the one-time passcode received from the first computing device matches the displayed one-time passcode, and in response, may send a message to the first computing device that it may proceed with a passcode reset process. In response, the first computing device may present a user interface display that gives the user an opportunity to reset the passcode thus recovering use of the first computing device. The communications between the first computing device and the second computing device via the direct device-to-device mesh network are illustrated in FIG. 5.

Various embodiments include methods of restoring a wireless communication device for which a user has forgotten the passcode using a second computing device. In some embodiments, the communications between second computing devices are configured to provide authentication of a user having access to two or more connected devices that are located in close proximity to each other to enable the computing devices to be communicatively coupled to a common, direct device-to-device mesh communications network. The authentication of a user using a particular first computing device and a second computing device may enable a user to reset a password, passcode, or similar codeword used to grant access to a computing device. Once authentication of the user has been successfully completed, a lost passcode may be reset to grant the user access to the computing device.

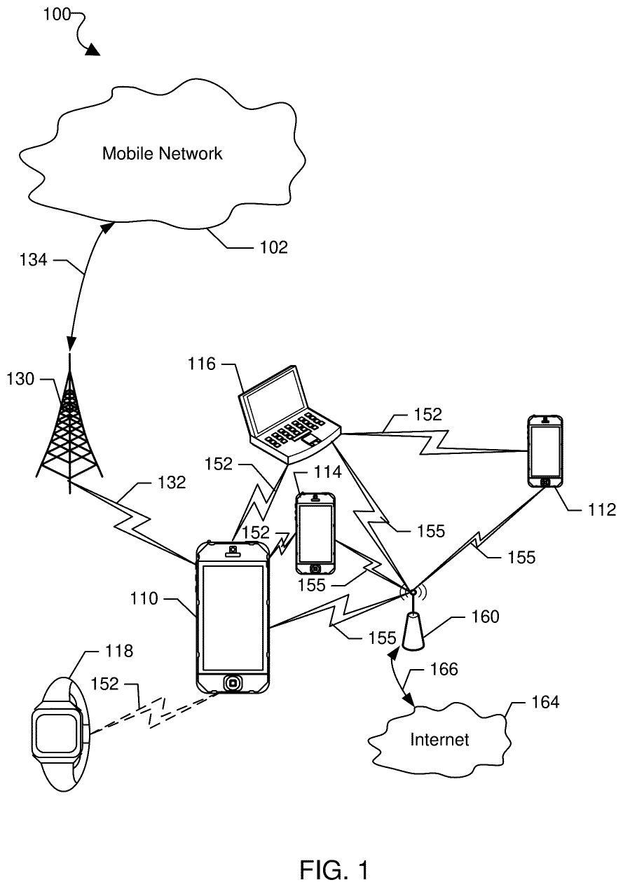

FIG. 1 is a communication system block diagram of mobile communications network suitable for use with various implementations. Various implementations may be implemented within a variety of communication systems 100, such as at least one mobile telephony network, an example of which is illustrated in FIG. 1. A mobile network 102 typically includes a plurality of cellular base stations (such as a base station 130).

The communication system 100 may include a plurality of computing devices 110, 112, 114, 116. A first computing device 110 may be in communication with the mobile network 102 through a cellular connection 132 to the base station 130. Other computing devices 112, 114, 116 may be in communication with the Internet 164 through a network connection 166 via a network access point 160.

The base station 130 may be in communication with the mobile network 102 over a wired connection 134. The cellular connection 132 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

The plurality of computing devices 110, 112, 114, 116 also may be connected to the wireless access point 160 supporting a local area network 155 among all of the computing devices connected to the network. The wireless access point 160 may be configured to connect to the Internet 164 or another network over a wired connection 166, such as to provide Internet access to the plurality of computing devices 110, 112, 114, 116. In the various implementations, the wireless access point 160 may include a processor configured to authenticated computing devices 110, 112, 114, 116 and pass device capability information among the authenticated computing devices 110, 112, 114, 116.

In addition to supporting the wireless communications to the telephony network 130, and to the wireless access point 160 supporting a local area network, each of the computing devices 110, 112, 114, 116 may be configured to establish wireless device-to-device (D2D) communication links 152. The device-to-device communication links 152 enable each of the computing devices 110, 112, 114, 116 to exchange data (such as call data) without communicating via the local area network or telephony networks. For example, the device-to-device communication links 152 may be established via Bluetooth®, Wi-Fi, LTE Direct, and other similar types of direct communications protocols.

In some implementations, the first computing device 110 may also establish a wireless device-to-device communication link 152 with a wearable computing device 118 used in connection with the first computing device 110. For example, the first computing device 110 may communicate over a Bluetooth® link with a Bluetooth-enabled personal computing device (such as a “smart watch”).

In the various implementations, a user may have lost or forgotten a passcode used to gain access to the first computing device 110. To regain access to the first computing device 110, the user may use one of the user's companion trusted computing devices 112, 114, 116, and 118 as a second computing device to reset the lost passcode to regain access to the first computing device 110.

Prior to use for regaining access to the first computing device 110, an application is loaded onto the first computing device 110 and the user's companion trusted computing devices 112, 114, 116, 118. Each of these computing devices are configured by the user to connect the computing devices to each other via a direct device-to-device mesh communications network as a trusted device. The configuration of each computing device may include specifying the direct device-to-device mesh communications network to be used to regain access to a computing device after a passcode is forgotten or lost. For example, the direct device-to-device mesh communications network may be specified by network ID, communications type, or similar identification designation and may include any access authentication credentials needed for the trusted devices to gain access to the network. The configuration also may include identifying each of the trusted devices to each other. For example, a trusted device may be identified by a computing device name, MAC address, or similar unique identifier to enable a computing device to recognize a connected device as being a trusted device. Once configured, any of the trusted devices may be used by one of the other trusted devices to regain access to that device using the method disclosed herein.

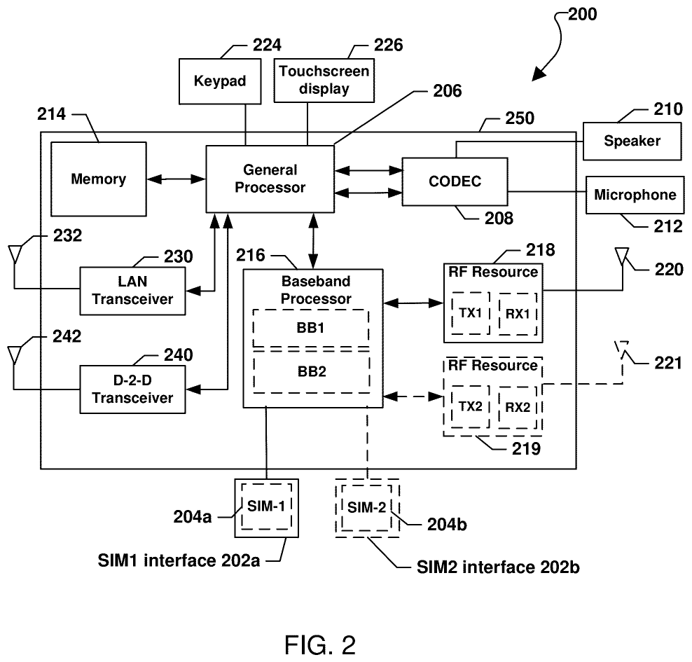

FIG. 2 is a functional block diagram of a computing device 200 suitable for implementing various implementations. With reference to FIGS. 1 and 2, the computing device 200 may be similar to one or more of the pluralities of computing devices 110, 112, 114, 116, 118. The computing device 200 may include a first subscriber identity module (SIM) interface 202a, which may receive a first identity module SIM-1 204a that is associated with a first subscription. The computing device 200 also may optionally include a second SIM interface 202b, which may receive an optional second identity module SIM-2 204b that is associated with a second subscription.

The computing device 200 may include at least one controller, such as a general processor 206, which may be coupled to a coder/decoder (CODEC) 208. The CODEC 208 may in turn be coupled to a speaker 210 and a microphone 212. The general processor 206 also may be coupled to the memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 also may store application data, such as an application that maintains a capability table for authenticated computing devices in a local area network (such as a home Wi-Fi network).

The RF resource 218 may be a transceiver that performs transmit/receive functions for each of the SIMs/RATs on the computing device 200. The RF resource 218 may include separate transmit and receive circuitry or may include a transceiver that combines transmitter and receiver functions. In some implementations, the RF resource 218 may include multiple receive circuitries. The RF resource 218 may be coupled to a wireless antenna (such as a wireless antenna 220). The RF resource 218 also may be coupled to the baseband modem processor 216. In some embodiments, the computing device 200 may include an optional RF resource 219 configured similarly to the RF resource 218 and coupled to an optional wireless antenna 221.

The general processor 206 may be coupled to a local area network transceiver 230, such as a Wi-Fi transceiver, which may be coupled to an antenna 232. The local area network transceiver 230 may be configured to establish communication links with a wireless access point, such as the wireless access point 160.

The general processor 206 also may be coupled to a computing device-two-device (D2D) transceiver 240, such as a Bluetooth transceiver, which may be coupled to an antenna 242. The D2D transceiver 230 may be configured to establish direct communication links with other computing devices, such as to exchange call data.

In various embodiments, the general processor 206, the memory 214, the baseband processor(s) 216, and the RF resources 218, 219 may be included in the computing device 200 as a system-on-chip 250. In some implementations, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the computing device 200 may include, but are not limited to, a keypad 224, a touchscreen display 226, and the microphone 212.

In some implementations, the keypad 224, the touchscreen display 226, may perform the function of receiving a request to initiate restoring a lost passcode from a user. For example, the touchscreen display 226 may receive a selection of a button or link to initiate the restoration of a lost passcode and the baseband processor 216 may perform the function of sending a request to a trusted companion device. For example, the touchscreen display 226 may receive input of a codeword as part of restoring a computing device for which the user has lost or forgotten the passcode. As another example, the touchscreen display 226 may display a codeword to the user for entry into the computing device 200 in response to a message from a trusted companion device. Interfaces may be provided between the various software modules and functions in the computing device 200 to enable communication between them.

In some embodiments, the computing device 200 may include the components shown in FIG. 2 without the radio access technology (RAT) communication connections. For example, a smart watch or tablet computing device may or may not provide cellular communication with other devices while communicating with devices using local area network (LAN) and direct device-to-device mesh network connections.

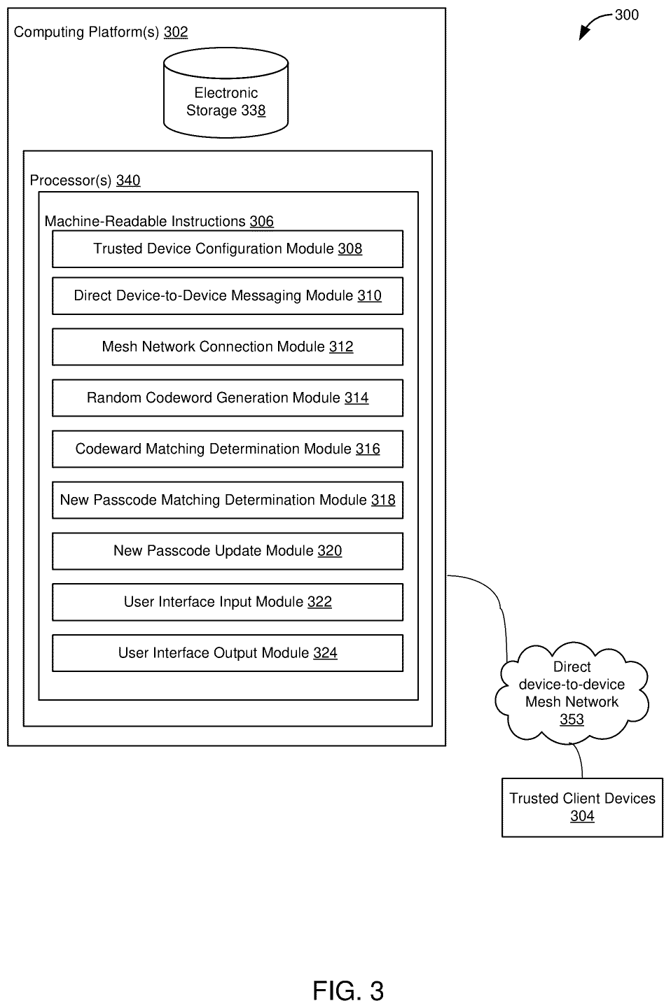

FIG. 3 illustrates a system configured for restoring a lost passcode on a first computing using a second computing device in accordance with various embodiments. With reference to FIGS. 1-3, some embodiments of system 300 may include one or more computing platforms 302 and/or one or more trusted platforms/devices 304. With reference to FIGS. 1-3, computing platform(s) 302 may include one or more computing devices (e.g., the computing device 110, 112, 114, 116, 118), and trusted platform(s) may include one or more companion trusted devices (e.g., the computing device 304). In some embodiments, the system 300 may include a wireless direct device-to-device network 353 for communicatively coupling one or more trusted client devices 304 in accordance with various embodiments.

Computing platform(s) 302 may be configured by machine-readable instructions 306 executing by one or more processors 340. Machine-readable instructions 306 may include one or more instruction modules. The instruction modules may include computer program modules.

The instruction modules may include a companion trusted device configuration module 308, a direct device-to-device network messaging module 310, a mesh network connection module 312, a random codeword generation 314, a codeword matching determination module 316, a new passcode matching determination module 318, a new passcode update module 320, a computing device user interface input module 322, a computing device user interface output module 324, and/or other instruction modules.

The companion trusted device configuration module 308 may generate configuration data sent to computing devices 302 to configure the computing devices to be companion trusted devices for companion trusted devices so configured enabling the companion trusted devices to be utilized when restoring a lost passcode to one of the computing devices. The companion trusted device configuration module 308 generated configuration data may include identification of the direct device-to-device mesh network 353 for use by the companion trusted devices, authentication data permitting a computing device to join the direct device-to-device mesh network 353, may identify of other companion trusted devices included within a set of trusted devices capable of restoring a lost passcode on one of the computing devices, and other configuration data to enable communication between the computing devices when restoring a lost passcode.

The direct device-to-device network messaging module 310 may perform operations to send and receive messages between a pair of trusted devices. The direct device-to-device network messaging module 310 generates messages transmitted to restore a lost passcode and communicates the generated messages over the direct device-to-device mesh network 353.

The mesh network connection module 312 may establish a connection between trusted devices over the direct device-to-device mesh network 353 when a companion trusted device is in proximity to computing devices enabling the computing devices to communicate with each other. A companion trusted device may attach to the direct device-to-device mesh network 353 enabling computing device 302 that also is one of the trusted devices to initiate a restoration of a lost passcode upon command from a user of the computing devices. The mesh network connection module 312 also may perform authentication of a trusted device when connecting the computing device to the direct device-to-device mesh network 353 as needed.

The random codeword generation 314 may generate a random codeword that is transmitted between a computing device 302 restoring a lost passcode and a companion trusted device enabling the restoration of a lost passcode in accordance with various embodiments. The randomly generated passcode may include a sequence of alpha-numeric characters capable of being input into the computing device 302 by a user. In some embodiments, the random codeword may include a sequence of numbers, for example, “8201” represents a 4-digit codeword. In some embodiments, the random codeword may include a sequence of numbers and letters, for example, “4SD7K0” represents a 6-digit alpha-numeric codeword. Codewords may be of any length and need only be easily entered by a user into a computing device 302 during restoration of a lost passcode.

The codeword matching determination module 316 may compare a randomly generated codeword sent to a companion trusted device with a received codeword sent by the companion trusted device as part of authenticating the computing device 302 and the companion trusted device to each other prior to the restoration of a passcode.

The new passcode matching determination module 318 may compare a pair of newly received passcodes received by a computing device 302 to reset its passcode following successful authentication of the computing device by exchanging codewords with a companion trusted device. A new passcode may be updated after a user has entered matching passcodes on more than one occasion to verify that the new passcode contains alpha-numeric values intended by a user. The new passcode matching determination module 318 may receive the multiple entries of the pass code from the computing device user interface input module 322 and may perform the comparison. When the entries match, the new passcode matching determination module 318 may provide the new passcode to the new passcode update module 320 for updating the passcode on the computing device 302.

The new passcode update module 320 may receive a new passcode from the new passcode matching determination module 318 for use in updating the computing device passcode on the computing device 302. The new passcode update module 320 may store the new passcode into electronic storage 338 on the computing device 302 for use to unlock the computing device by a user. The new passcode update module 320 is responsible for communicating with an operating system on the computing device as the passcode used to unlock a computing device 302 may be maintained within the operating system in different ways depending upon the requirements of any particular operating system.

The user interface input module 322 may accept input data from users via an input device associated with the computing device 302. The input devices may include touchscreen display devices, keyboards, pointing devices, voice activated audio receiving devices, and similar mechanisms for a user to input codewords and passcodes during the restoration of a lost passcode in accordance with various embodiments.

The user interface output module 324 may accept data from various modules for display to a user via display device associated with the computing device 302. The display devices may include touchscreen display devices, voice activated audio output devices, and similar mechanisms for a user to receive codewords and passcodes for entry as needed during the restoration of a lost passcode in accordance with various embodiments.

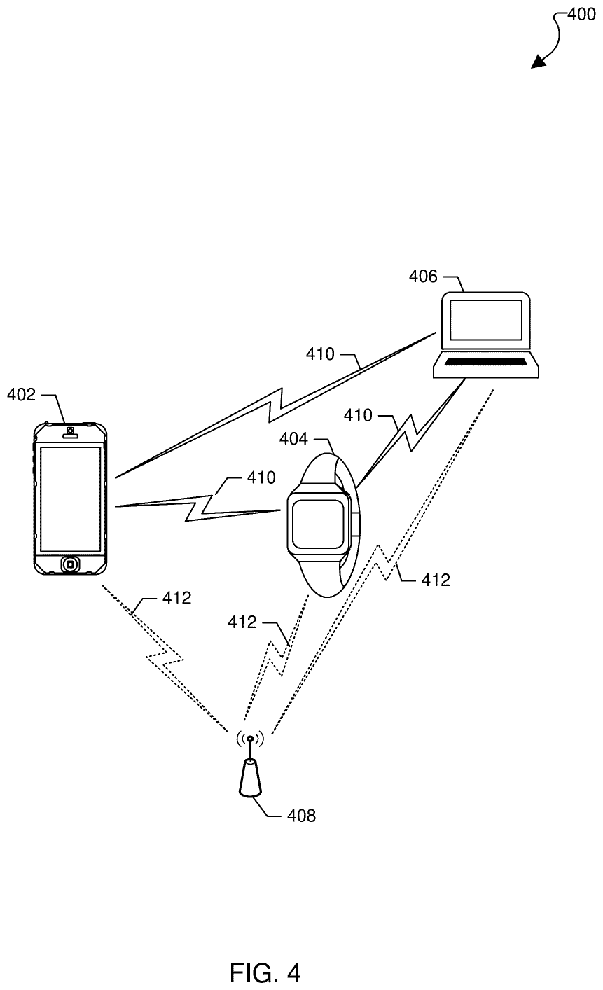

FIG. 4 is a system block diagram illustrating restoring a lost passcode on a first computing device using a companion trusted second computing device in accordance with various embodiments. With reference to FIGS. 1-4, the system 400 is an example of an embodiment for restoration of a lost passcode on one of one or more second computing devices 402, 404, 406 communicating with each other over a direct device-to-device mesh network 410 in accordance with various embodiments. The user's computing devices 402, 404, 406 may normally communicate via a wireless local area network 412 supported by a wireless hotspot 408, such as a Wi-Fi router. In an example embodiment, a first computing device 402 may use a lost passcode entered by a user to permit the user to gain access to the operation of the first computing device 402. A pair of trusted computing devices 404, 406 also are available to the user and have been configured to function as second computing devices for all three of the computing devices. Each of the trusted devices may utilize a different passcode to gain access to the operation of the corresponding device. One or more of these devices may utilize a biometric authentication mechanism supported by the corresponding device in addition to and/or instead of an alpha-numeric passcode.

The user may utilize the trusted computing devices 404, 406 to authenticate the user to be authorized to access each of the trusted devices and update the corresponding passcode on each computing device. The user may initiate the restoration process using a first computing device 402 having the lost passcode. The first computing device 402 may communicate with one of the other trusted computing devices 404, 406 currently connected to the direct device-to-device mesh network 410.

As noted, each of the computing devices may attach to the direct device-to-device mesh network 410 permitting each trusted computing device to recognize a request from one of the other trusted devices to restore its passcode. The first computing device 402 and a selected trusted computing device 404 (second computing device), for example a smart watch, may communicate directly with each other via the direct device-to-device mesh network 410 to exchange messages in accordance with various embodiments. Additional details regarding the exchange of messages are described in reference to FIG. 5.

FIG. 5 is a message flow diagram illustrating communications involved in restoring a lost passcode on a first computing using a second computing device in accordance with various embodiments. With reference to FIGS. 1-5, the message flow 500 illustrates a sequence of messages between a first computing device 402 and a second computing device 404 as described in the example illustrated in FIG. 4. In message flow 500, the first computing device 501 includes a lost passcode and utilizes communications with a second computing device 502 to perform the passcode restoration. The first computing device 501 and the second computing device 502 may correspond to any of the companion trusted devices 402, 404, 406 that have been configured to be trusted devices for each other in accordance with various embodiments.

Restoration of a lost passcode may begin with a user of the first computing device 501 clicking on a forgot passcode button on a display of the computing device. The first computing device 501 may transmit an initiate restore passcode message 511 to the second computing device 502 using the direct device-to-device mesh network 410. The second computing device 502 may respond by transmitting a passcode change request approval message 512 back to the first computing device 501.

Upon receipt of the passcode change request approval message 512, the first computing device 501 may generate and display a randomly generated pairing pin or codeword on its display in operation 504. The user may read the generated pairing pin or codeword 513 and enter the codeword into a user interface of the second computing device 502, which receives the entered pairing pin or codeword in operation 506. The second computing device 502 may transmit the received codeword to the first computing device 501 in a first pairing message 515.

Upon receipt of the first pairing message 515, the first computing device 501 may compare the first generated codeword to the first received codeword from the received message to determine whether the two first codewords match each other. When the two first codewords match, the second computing device 502 has successfully authenticated to the first computing device 501 that may result in transmission of a first authentication acknowledgement message 516 from the first computing device 501 to the second computing device 502.

Receipt of the first authentication acknowledgement message 516 may cause the second computing device 502 to generate and display a randomly second generated codeword on its display in operation 508. The user may read the second codeword 517 and enter the codeword into the first computing device 501 such that the first computing device 501 receives the codeword in operation 510. The first computing device 501 may response to the entry of the second codeword by transmitting the received codeword to the second computing device 502 in a second pairing message 518.

Upon receipt of the second pairing message 518, the second computing device 502 may compare the second generated codeword with the received second codeword received from the first computing device 501. When the two second codewords match, the second computing device 502 has successfully authenticated the first computing device 501, and in response the second computing device 502 may transmit a second authentication acknowledgement message 519 to the first computing device 501.

In response to receiving the second authentication acknowledgement message 519, the first computing device 501 may initiate a reset passcode operation 520. In the reset passcode operation 520, the user may enter a new passcode into the first computing device 501 two or more times in order to ensure that the user has entered a desired passcode as intended. The first computing device 501 may compare the received new passcodes with each other. In response to determining that the two or more entered passcodes match, the new passcode may be saved by the first computing device 501 for use by the user to access the first computing device 501. Thereafter the user may unlock the first computing device 501 is an ordinary way using the newly saved passcode.

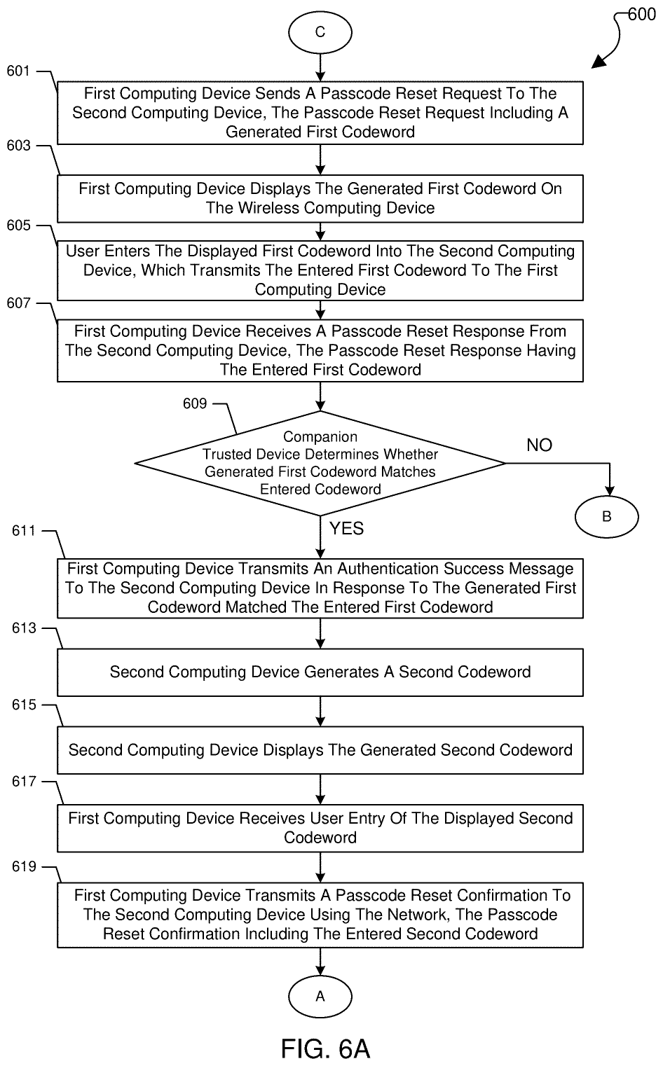

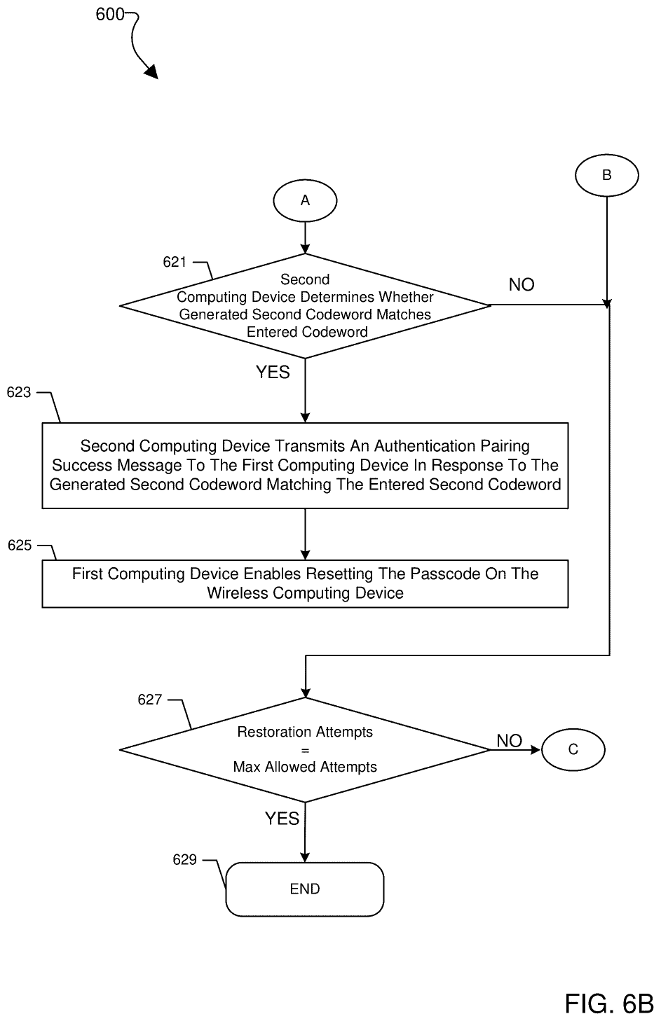

FIGS. 6A and 6B are process flow diagrams illustrating an example method 600 for restoring a lost passcode on a first computing device using a companion trusted device (second computing device) in accordance with various embodiments. With reference to FIGS. 1-6A, the method 600 illustrates operation of a first computing device 402 as described in the example illustrated in FIGS. 4-5. The operations of the method 600 may be performed by the first and second computing devices by a processing system (e.g., 110, 112, 114, 116, 118, 200) on each computing device, the processing system including one or more processors (e.g., 206, 216, 340) and/or hardware elements, any one or combination of which may be configured with software or firmware to perform any of the operations of the method 600. To encompass any of the processor(s), hardware elements and software elements that may be involved in performing the method 600, the elements performing method operations are referred to as a “processing system.” Further, means for performing functions of the method 600 may include the processing system (e.g., 110, 112, 114, 116, 118, 200) including one or more processors (e.g., 206, 216, 340), memory 214, a radio resource 218, and one or more cameras.

In block 601, the first computing device 501 may generate an initiate restore passcode message 511, the initiate restores passcode message 511 having a randomly first generated codeword. The first generated codeword may be displayed the display device of the first computing device 501 in block 603.

The user may read the first codeword and enter it into the second computing device 502 so that the codeword is received by the second computing device 502 in block 605. In response, the second computing device 502 may transmit the received first codeword to the first computing device via the direct device-to-device mesh network in the form of a first pairing message 515.

In block 607, the first computing device 501 may receive the first pairing message 515 containing the first received codeword.

In determination block 609, the first computing device 501 may determine whether the first generated codeword matches the received codeword received from the second computing device 502.

In response to determining that the first generated codeword does not matches the received codeword received from the second computing device 502 (i.e., determination block 609=“No”), the first computing device 501 may perform no operation and proceed to determination block 627, shown on FIG. 6B and marked as “B”, to determine whether the user has exhausted a maximum number of attempts to pair the computing devices.

In response to determining that the first generated codeword matches the first codeword received from the second computing device 502 (i.e., determination block 609=“Yes”), the first computing device 501 may transmit a first authentication acknowledgement message 516 to the second computing device 502 indicating successfully authenticating the second computing device 502 to the first computing device 501 in block 611. The first computing device 501 may transmit a first authentication acknowledgement message 516 via the direct device-to-device mesh network.

In block 613, in response to receiving the first authentication acknowledgement message 516, the second computing device 502 may generate a random second generated codeword, which is then displayed on the display device of the second computing device 502 in block 615.

In block 617, the user may read the second codeword and enter it into the first computing device 501 so that the second codeword is received by the first computing device 501.

In block 619, the first computing device 501 transmits a passcode reset confirmation message containing the received second codeword to the second computing device 502 via the direct device-to-device mesh network.

Referring to FIG. 6B, in determination block 621, the second computing device 502 may receive the passcode reset confirmation message containing the received second codeword, and determine whether the second generated codeword matches the received second codeword received from first computing device 501.

In response to determining that the second generated codeword does not match the second codeword received from the first computing device 501 (i.e., determination block 621=“No”), the second computing device 502 may perform no operation and proceed to determination block 627 (marked as “B”) to determine whether the user has exhausted a maximum number of attempts to pair the computing devices.

In response to determining that second generated codeword matches the second codeword received from the first computing device 501 (i.e., determination block 621=“Yes”), the second computing device 502 may transmit a second authentication acknowledgement message 519 to the first computing device 501 indicating successfully authenticating the second computing device 502 to the first computing device 501 in block 623.

Upon receiving the second authentication acknowledgement message 519, the first computing device 501 may reset the passcode in block 625. As described, the operations to reset the passcode may include prompting the user to enter a new passcode into a user interface two or more times to confirm a successful passcode entry.

When either the first generated codeword does not match the first received codeword or the second generated codeword does not match the second received codeword (i.e., determination block 621=“NO”), the second computing device 502 may determine whether the user has unsuccessfully attempted to restore the passcode a maximum number of times in determination block 627. Limiting the number of attempts permitted to reset the passcode may provide added security in the overall process.

In response to determining that the user has not exceeded the maximum number of attempts to reset the passcode (i.e., determination block 627=“No”), the first computing device 501 may repeat the operations of the method 600 by sending another passcode reset request to the second computing device 502 including another generated first codeword in block 601 as described (path “C”).

In response to determining that the user's unsuccessful password restore attempts has exceeded maximum number of attempts (i.e., determination block 627=“Yes”), the second computing device 501 may terminate the user's attempt to restore a lost passcode and end the process in block 629.

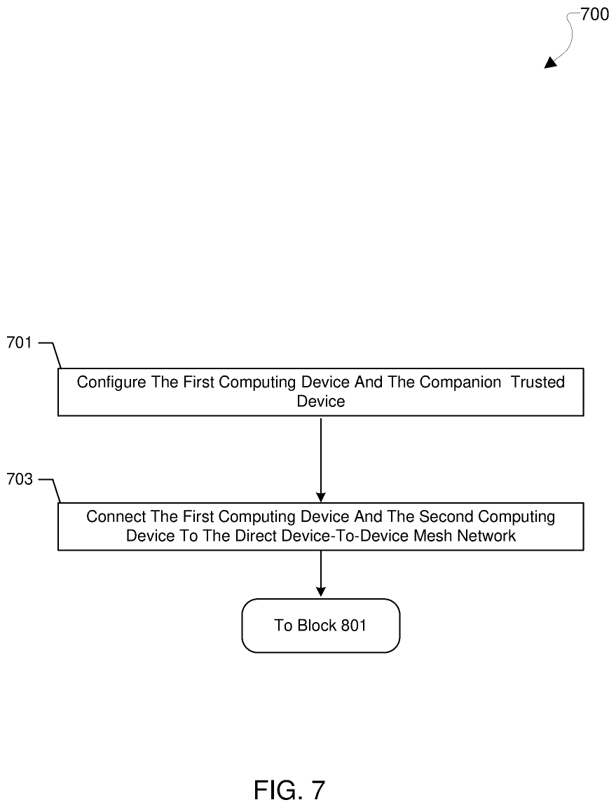

FIG. 7 is a process flow diagram of an example method 700 for restoring a lost passcode on a first computing using a second computing device in accordance with various embodiments. With reference to FIGS. 1-7, the operations of the method 700 may be performed by a processing system (e.g., 110, 112, 114, 116, 118, 200) including one or more processors (e.g., 206, 216, 340) configured with software or firmware and/or hardware elements, any one or combination of which may be configured to perform any of the operations of the method 700. To encompass any of the processor(s), hardware elements and software elements that may be involved in performing the method 700, the elements performing method operations are referred to as a “processing system.” Further, means for performing functions of the method 700 may include the processing system (e.g., 110, 112, 114, 116, 118, 200) including one or more processors (e.g., 206, 216, 340), memory 214, and a radio resource 218.

In block 701, the first computing device 501 and the second computing device 502 may be configured to operate as trusted computing devices for each other over a direct device-to-device mesh network. Once configured, the first computing device 501 and second computing device 502 may connect to the direct device-to-device mesh network when in proximity with each other permitting communications in block 703 as described herein. Once connected to the direct device-to-device mesh network, a user may initiate a restoration of a lost passcode in block 601 of FIG. 6A.

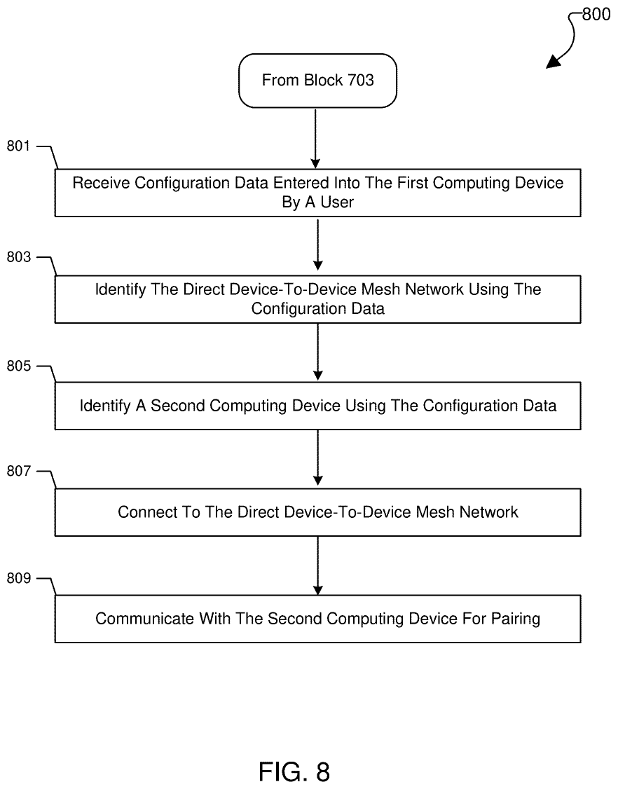

FIG. 8 is a process flow diagram of an example method 800 for restoring a lost passcode on a first computing using a second computing device in accordance with various embodiments. With reference to FIGS. 1-8, the method 800 illustrates configuring computing device 501 and second computing device 502 in block 701 to operate as trusted devices for each other over a direct device-to-device mesh network as described in the example illustrated in FIGS. 4-5. The operations of the method 800 may be performed by a processing system (e.g., 110, 112, 114, 116, 118, 200) including one or more processors (e.g., 206, 216, 340 and/or hardware elements, any one or combination of which may be configured with software or firmware to perform any of the operations of the method 800. To encompass any of the processor(s), hardware elements and software elements that may be involved in performing the method 800, the elements performing method operations are referred to as a “processing system.” Further, means for performing functions of the method 800 may include the processing system (e.g., 110, 112, 114, 116, 118, 200) including one or more processors (e.g., 206, 216, 340), memory 214, a radio resource 218, and one or more cameras.

In block 801, a user may enter configuration data into the first computing device 501 so that the data is received and stored by the first computing device. In block 803, the first computing device 501 may use the received configuration data to identify a direct device-to-device mesh network for use in communicating with other trusted computing devices. In block 805, the first computing device 501 may identify one or more other trusted computing devices to serve as the second computing device 502 using the configuration data.

In block 807, the first computing device 501 may connect to the direct device-to-device mesh network. In block 809, computing device 501 may communicate with other computing devices over the direct device-to-device mesh network to complete pairing as trusted computing devices.

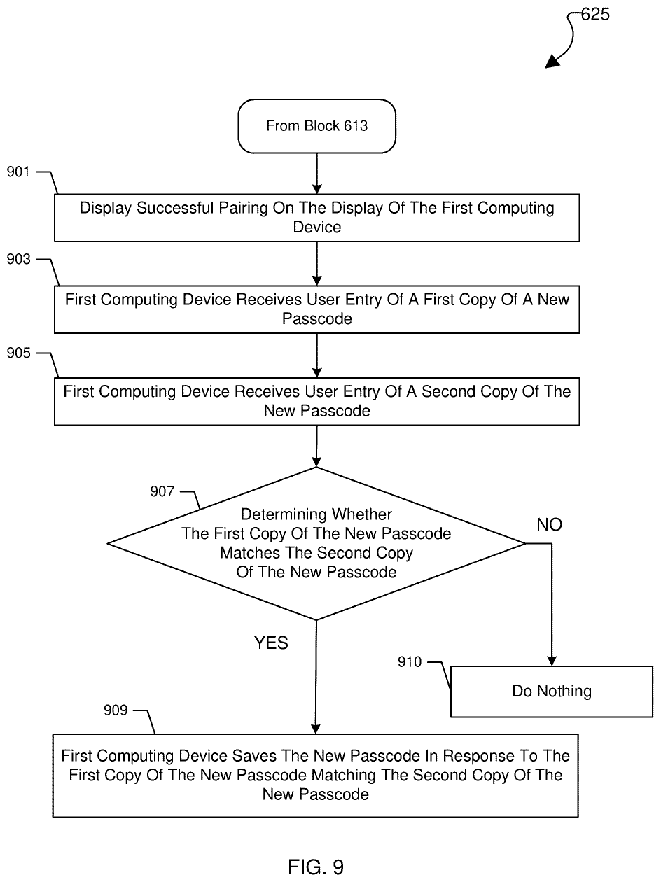

FIG. 9 is a process flow diagram of an example of operations that may be performed in block 625 of the method 600 for restoring a lost passcode on a first computing using a second computing device in accordance with various embodiments. With reference to FIGS. 1-9, the operations of block 615 may be performed by a processing system (e.g., 110, 112, 114, 116, 118, 200) including one or more processors (e.g., 206, 216, 340) and/or hardware elements, any one or combination of which may be configured with software or firmware to perform any of the operations of block 625. To encompass any of the processor(s), hardware elements and software elements that may be involved in performing the operations in block 625, the elements performing method operations are referred to as a “processing system.” Further, means for performing functions of the operations in block 625 may include the processing system (e.g., 110, 112, 114, 116, 118, 200) including one or more processors (e.g., 206, 216, 340), memory 214, a radio resource 218, and one or more cameras.

In block 901, the first computing device 501 may display success in authenticating the first computing device 501 and the second computing device 502, and initiate the process for resetting the passcode used to give the user access to the first computing device 501.

In block 903, the user may enter a first copy of a new passcode into a user interface of the first computing device 501, and the first computing device processing system may receive the first entry of the new passcode. In block 905, the user may enter a second copy of the new passcode into the user interface of the first computing device 501 so that the new passcode is received by the first computing device.

In determination block 907, the first computing device 501 may determine whether the first new passcode matches the second new passcode.

In response to determining that the first new passcode does not match the second new passcode (i.e., determination block 907=“No”), the first computing device 501 may output an error message that the passcodes are mismatched, may permit the user to reenter the passcode by displaying another user input prompt in block 903, or perform no operation in block 910.

In response to determining that the first new passcode matches the second new passcode (i.e., determination block 907=“Yes”), the first computing device 501 may save the new passcode in memory in block 909. For example, the first computing device 501 may store the new passcode in secure memory for use in granting the user access to the computing device in the future.

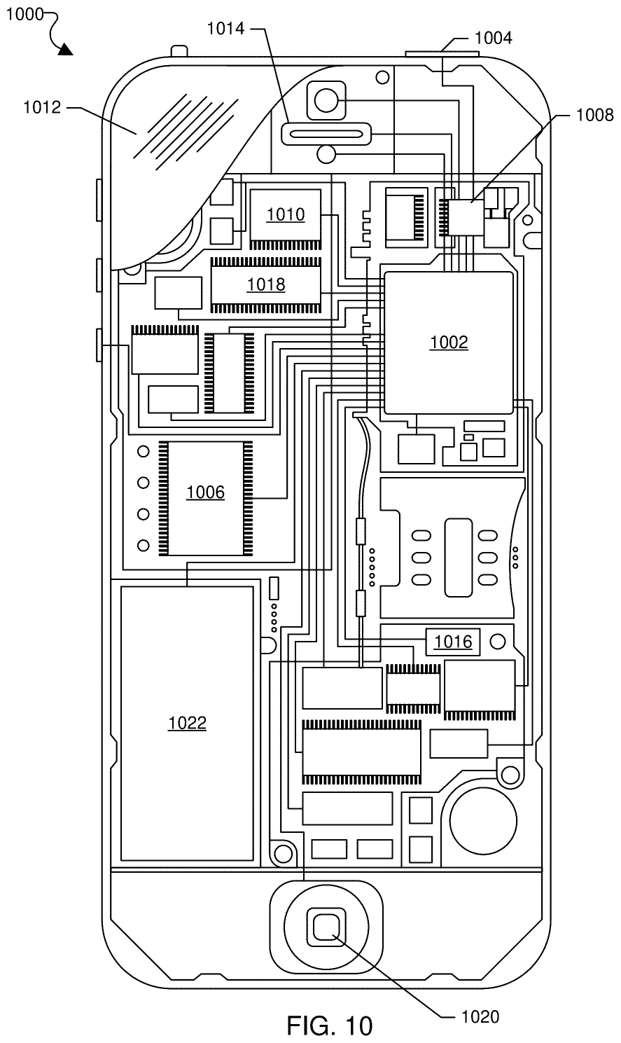

Various embodiments may be implemented on a variety of computing devices (e.g., 110, 112, 114, 116, 118, 402, 404, 406, 501, and 502), an example of which is illustrated in FIG. 10 in the form of a smartphone 1000. With reference to FIGS. 1-10, the smartphone 1000 may include a first SOC 1002 (e.g., a SOC-CPU) coupled to a second SOC 1018 (e.g., a 5G capable SOC). The first and second SOCs 1002, 1018 may be coupled to internal memory 1006, 1016, a display 1012, a speaker 1014, all of which may be powered by a battery 1022. Additionally, the smartphone 1000 may include an antenna 1004 for sending and receiving electromagnetic radiation that may be connected to a wireless data link and/or cellular telephone transceiver 1008 coupled to one or more processors in the first and/or second SOCs 1002, 1018. Smartphones 1000 typically also include menu selection buttons or rocker switches 1020 for receiving user inputs.

A smartphone 1000 also includes a sound encoding/decoding (CODEC) circuit 1010, which digitizes sound received from a microphone into data packets suitable for wireless transmission and decodes received sound data packets to generate analog signals that are provided to the speaker to generate sound. Also, one or more of the processors in the first and second SOCs 1002, 1018, wireless transceiver 1008 and CODEC 1010 may include a digital signal processor (DSP) circuit (not shown separately).

The processors the smartphone 1000 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor dedicated to wireless communication functions and one processor dedicated to running other applications. Typically, software applications may be stored in memory 1006, 1016 before they are accessed and loaded into the processor. The processors may include internal memory sufficient to store the application software instructions.

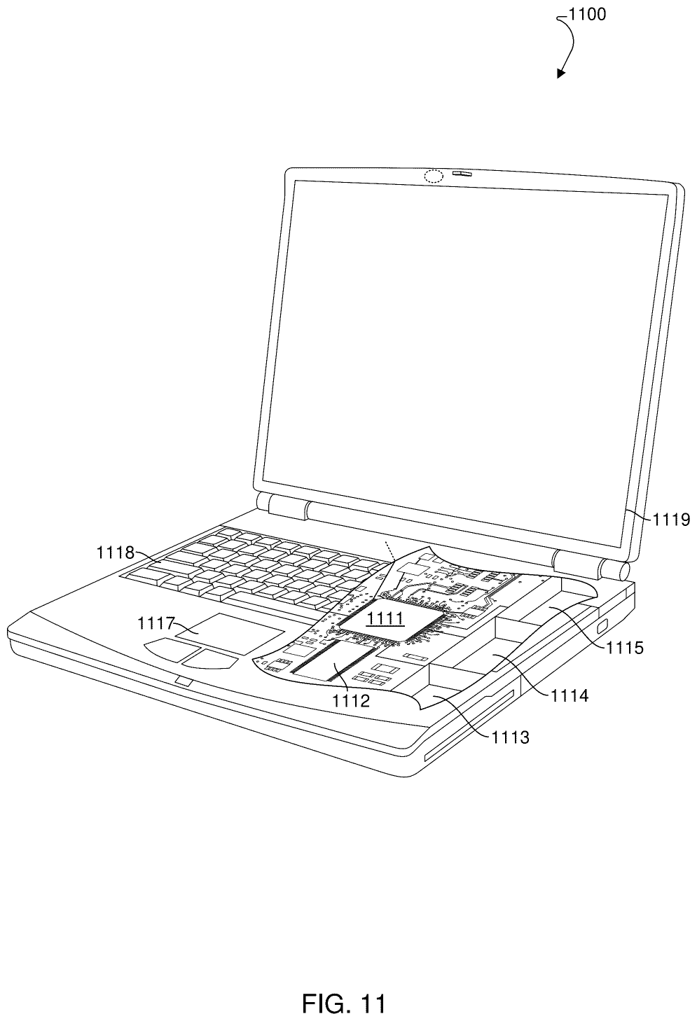

Various embodiments (including, but not limited to, the embodiments discussed above with reference to FIG. 3), may also be implemented within a variety of personal computing devices, an example of which in the form of a laptop computer 1100 is illustrated in FIG. 11. With reference to FIGS. 1-11, the laptop computer 1100 (which may correspond, for example, to the computing devices 110, 200 in FIGS. 1-2) may include a touchpad touch surface 1117 that serves as the computer's pointing device, and thus may receive drag, scroll, and flick gestures similar to those implemented on computing devices equipped with a touchscreen display as described. A laptop computer 1100 will typically include a processor 1111 coupled to volatile memory 1112 and a large capacity nonvolatile memory, such as a disk drive 1113 of Flash memory. The computer 1100 may also include a floppy disc drive 1114 and a compact disc (CD) drive 1115 coupled to the processor 1111. The computer 1100 may also include a number of connector ports coupled to the processor 1111 for establishing data connections or receiving external memory devices, such as a USB™ or FIREWIRE® connector sockets, or other network connection circuits for coupling the processor 1111 to a network. In a notebook configuration, the computer housing includes the touchpad 1117, the keyboard 1118, and the display 1119 all coupled to the processor 1111. Other configurations of the computing device may include a computer mouse or trackball coupled to the processor (e.g., via a USB™ input) as are well known, which may also be used in conjunction with various embodiments.

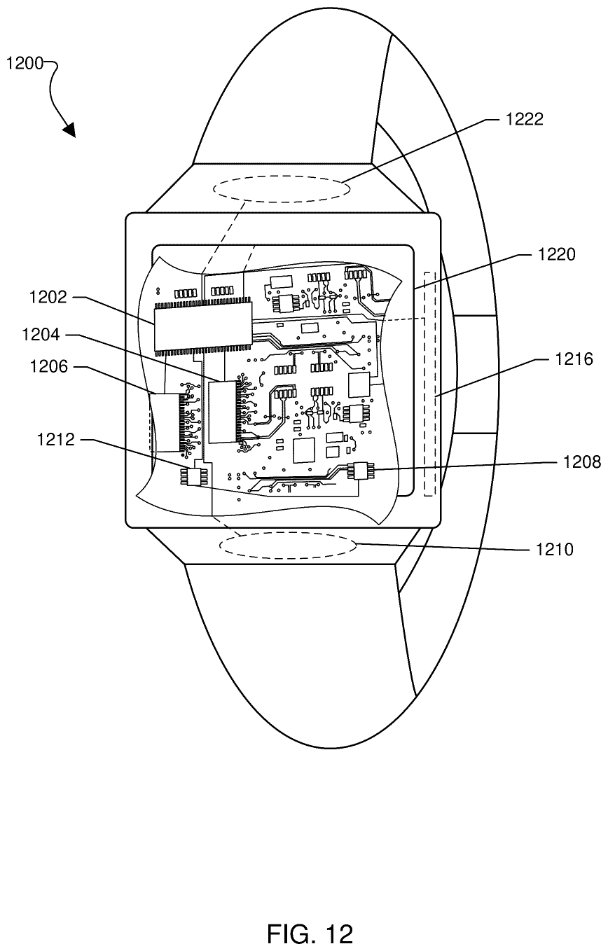

Various embodiments may be implemented within a variety of computing devices, such as a wearable computing device. FIG. 12 illustrates an example wearable computing device in the form of a smart watch 1200. A smart watch 1200 may include a processor 1202 coupled to internal memories 1204 and 1206. Internal memories 1204 and 1206 may be volatile or non-volatile memories and may also be secure and/or encrypted memories, or unsecured and/or unencrypted memories, or any combination thereof. The processor 1202 may also be coupled to a touchscreen display 1220, such as a resistive-sensing touchscreen, capacitive-sensing touchscreen infrared sensing touchscreen, or the like. Additionally, the smart watch 1200 may have one or more antenna for sending and receiving electromagnetic radiation that may be connected to one or more wireless transceivers 1208, 1212, such as one or more BLUETOOTH® transceivers, Peanut transceivers, Wi-Fi transceivers, ANT+transceivers, etc., which may be coupled to the processor 1202. The smart watch 1200 may also include physical virtual buttons 1222 and 1210 for receiving user inputs as well as a slide sensor 1216 for receiving user inputs.

With reference to FIGS. 1-12, the processors 1002, 1111, and 1202 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 1006, 1016, 1112, 1113, 1204, and 1206 before they are accessed and loaded into the processors 1002, 1111, and 1202. The processors 1002, 1111, and 1202 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1002, 1111, and 1202, including internal memory or removable memory plugged into the computing device and memory within processors 1002, 1111, and 1202, themselves.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

Implementation examples are described in the following paragraphs. While some of the following implementation examples are described in terms of example methods, further example implementations may include the example methods discussed in the following paragraphs implemented by a computing device 110 and trusted computing devices 112, 114, 116, and 118 including a processor configured with processor-executable instructions to perform operations of the methods of the following implementation examples; example methods discussed in the following paragraphs implemented by a computing device 110 and computing devices 112, 114, 116, and 118 including means for performing functions of the methods of the following implementation examples; and example methods discussed in the following paragraphs may include by a computing device 110 and trusted computing devices 112, 114, 116, and 118 that may be implemented as a non-transitory processor-readable storage medium having stored thereon processor-executable instructions configured to cause a processors 1002, 1111, and 1202 to perform the operations of the methods of the following implementation examples.

Example 1. A method for restoring a lost passcode on a first computing device using a second computing device via a wireless network, the method including: transmitting a passcode reset request to the second computing device via the wireless network, the passcode reset request including a first generated codeword; displaying the first generated codeword on the first computing device; receiving a passcode reset response from the second computing device via the wireless network, the passcode reset response including a first received codeword; determining whether the first generated codeword matches the first received codeword included in the passcode reset response; transmitting an authentication success message to the second computing device via the wireless network in response to the first generated codeword matching the first received codeword; receiving a user input of a second received codeword in the computing device; transmitting a passcode reset confirmation to the second computing device via the wireless network, the passcode reset confirmation including the second received codeword; receiving an authentication pairing success message from the second computing device; and resetting the passcode on the first computing device in response to receiving the authentication pairing success message from the second computing device.

Example 2. The method of example 1, further including configuring the first computing device to communicate via the wireless network; and connecting the first computing device to the wireless network.

Example 3. The method of either of examples 1 or 2, further including: receiving configuration data regarding the wireless network by the computing device; identifying the wireless network using the configuration data; identifying the second computing device using the configuration data; connecting to the wireless network; and communicating with the second computing device for pairing.

Example 4. The method of any of examples 1-3, in which resetting the passcode on the computing device includes: displaying successful pairing on a display of the computing device; receiving a first copy of a new passcode; receiving a second copy of the new passcode; determining whether the first copy of the new passcode matches the second copy of the new passcode; and saving the new passcode on the computing device in response to the first copy of the new passcode matching the second copy of the new passcode.

Example 5. The method of any of examples 1-4, further including generating a random number and using the generated random number in the first generated codeword.

Example 6. The method of any of examples 1-5, in which the computing device is one of a smartphone, a smartwatch, a tablet device, a desktop computer, or a laptop computer.

Example 7. The method of any of examples 1-6, in which the wireless network is a direct device-to-device mesh network that the first computing device automatically joins in response to detecting the wireless direct device-to-device mesh network.

Example 8. The method of any of examples 1-7, in which the wireless network includes one of a Wi-Fi network, a ZigBEE network, or a Bluetooth network.

Example 9. A method performed by a second computing device for restoring a lost passcode on a first computing device, the method including: receiving a passcode reset request from the first computing device, the passcode reset request including a first generated codeword; displaying the first generated codeword on a display of the second computing device; receiving a user input by the second computing device of a first received codeword; transmitting to the first computing device a passcode reset response via a wireless network, the passcode reset response including the first received codeword; receiving an authentication success message from the first computing device; generating a second codeword in response to receiving the authentication success message from the first computing device; displaying the second generated codeword on a display of the second computing device; receiving a passcode reset confirmation from the first computing device via the wireless network, the passcode reset confirmation including a second received codeword; determining whether the second generated codeword matches the second received codeword included in the passcode reset confirmation; and transmitting an authentication pairing success message to the first computing device in response to determining that the second generated codeword matches the second received codeword included in the passcode reset confirmation.

Example 10. The method of example 9, further including configuring the second computing device; and connecting the second computing device to the wireless network.

Example 11. The method of either of examples 9-10, in which configuring the second computing device includes: receiving configuration data by the second computing device; identifying the wireless network using the configuration data; identifying the first computing device using the configuration data; connecting to the wireless network; and communicating with the first computing device for pairing.

Example 12. The method of any of examples 9-11, further comprising generating a random number and using the generated random number in the second generated codeword.

Example 13. The method of any of examples 9-12, in which the second computing device is one of a smartphone, a smartwatch, a tablet device, a desktop computer, or a laptop computer.

Example 14. The method of any of examples 9-13, in which the wireless network is a direct device-to-device mesh network in which the computing device automatically join the direct device-to-device mesh network in response to detecting the direct device-to-device mesh network.

Example 15. The method of example 14, in which the wireless network includes one of a Wi-Fi network, a ZigBEE network, or a Bluetooth network.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 600, 700, and/or 800 may be substituted for or combined with one or more operations of the methods 600, 700 and/or 800.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In some embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the various embodiments. Thus, the various embodiments are not intended to be limited to the embodiments shown herein but are to be accorded the widest scope consistent with the following claims and the principles and novel features disclosed herein.

What is claimed is:

1. A method for restoring a lost passcode on a first computing device using a second computing device via a wireless network, the method comprising:
transmitting a passcode reset request to the second computing device via the wireless network, the passcode reset request including a first generated codeword;
displaying the first generated codeword on the first computing device;
receiving a passcode reset response from the second computing device via the wireless network, the passcode reset response including a first received codeword;
determining whether the first generated codeword matches the first received codeword included in the passcode reset response;
transmitting an authentication success message to the second computing device via the wireless network in response to the first generated codeword matching the first received codeword;
receiving a user input of a second received codeword in the computing device;
transmitting a passcode reset confirmation to the second computing device via the wireless network, the passcode reset confirmation including the second received codeword;
receiving an authentication pairing success message from the second computing device; and
resetting the passcode on the first computing device in response to receiving the authentication pairing success message from the second computing device.

2. The method of claim 1, further comprising:
configuring the first computing device to communicate via the wireless network; and
connecting the first computing device to the wireless network.

3. The method of claim 1, further comprising:
receiving configuration data regarding the wireless network by the computing device;
identifying the wireless network using the configuration data;
identifying the second computing device using the configuration data;
connecting to the wireless network; and
communicating with the second computing device for pairing.

4. The method of claim 1, wherein resetting the passcode on the computing device comprises:
displaying successful pairing on a display of the computing device;
receiving a first copy of a new passcode;
receiving a second copy of the new passcode;
determining whether the first copy of the new passcode matches the second copy of the new passcode; and
saving the new passcode on the computing device in response to the first copy of the new passcode matching the second copy of the new passcode.

5. The method of claim 1, further comprising generating a random number and using the generated random number in the first generated codeword.

6. The method of claim 1, wherein the computing device is one of a smartphone, a smartwatch, a tablet device, a desktop computer, or a laptop computer.

7. The method of claim 1, wherein the wireless network is a direct device-to-device mesh network that the first computing device automatically joins in response to detecting the wireless direct device-to-device mesh network.

8. The method of claim 7, wherein the wireless network comprises one of a Wi-Fi network, a ZigBEE network, or a Bluetooth network.

9. A method performed by a second computing device for restoring a lost passcode on a first computing device, the method comprising:
receiving a passcode reset request from the first computing device, the passcode reset request including a first generated codeword;
displaying the first generated codeword on a display of the second computing device;
receiving a user input by the second computing device of a first received codeword;
transmitting to the first computing device a passcode reset response via a wireless network, the passcode reset response including the first received codeword;
receiving an authentication success message from the first computing device;
generating a second codeword in response to receiving the authentication success message from the first computing device;
displaying the second generated codeword on a display of the second computing device;
receiving a passcode reset confirmation from the first computing device via the wireless network, the passcode reset confirmation including a second received codeword;
determining whether the second generated codeword matches the second codeword included in the passcode reset confirmation; and
transmitting an authentication pairing success message to the first computing device in response to determining that the second generated codeword matches the second codeword included in the passcode reset confirmation.

10. The method of claim 9, further comprising:
configuring the second computing device; and
connecting the second computing device and to the wireless network.

11. The method of claim 10, wherein configuring the second computing device comprises:
receiving configuration data by the second computing device;
identifying the wireless network using the configuration data;
identifying the first computing device using the configuration data;
connecting to the wireless network; and
communicating with the first computing device for pairing.

12. The method of claim 9, comprising generating a random number and using the generated random number in the first generated codeword.

13. The method of claim 9, wherein the second computing device is one of a smartphone, a smartwatch, a tablet device, a desktop computer, or a laptop computer.

14. The method of claim 9, wherein the wireless network is a direct device-to-device mesh network in which the computing device automatically joins the direct device-to-device mesh network in response to detecting the direct device-to-device mesh network.

15. The method of claim 9, wherein the wireless network comprises one of a Wi-Fi network, a ZigBEE network, or a Bluetooth network.

16. A first computing device, comprising:
a memory;
a display;
a transceiver configured to communicate with a second computing device via a wireless network; and
a processing system coupled to the memory, the display, and the transceiver, wherein at least one processor of the processing system is configured to:
generate a first generated codeword;
transmit a passcode reset request to the second computing device via the wireless network, the passcode reset request including the first generated codeword;
display the first generated codeword on the display;
receive a passcode reset response from the second computing device via the wireless network, the passcode reset response including a first received codeword;
determine whether the first generated codeword matches the first received codeword in response to receiving the passcode reset response;
transmit an authentication success message to the second computing device via the wireless network in response to the first generated codeword matching the first received codeword;
receive a user input of a second received codeword;
transmit a passcode reset confirmation to the second computing device via the wireless network, the passcode reset confirmation including the received second codeword;
receive an authentication pairing success message from the second computing device via the wireless network; and
reset the passcode on the first computing device in response to receiving the authentication pairing success message.

17. The first computing device of claim 16, wherein the at least one processor is further configured to:
configure the second computing device; and
connect the second computing device to the wireless network.

18. The first computing device of claim 17, wherein the at least one processor is further configured to configure the second computing device by:
receiving configuration data;
identifying the wireless network using the configuration data;
identifying the second computing device using the configuration data;
connecting to the wireless network; and
communicating with the second computing device for pairing.

19. The first computing device of claim 16, wherein the at least one processor is further configured to reset the passcode on the second computing device by:
displaying successful pairing onto the display of the second computing device;
receiving a first copy of a new passcode;
receiving a second copy of the new passcode;
determining whether the first copy of the new passcode matches the second copy of the new passcode; and
saving the new passcode on the computing device in response to the first copy of the new passcode matching the second copy of the new passcode.

20. The first computing device of claim 16, wherein the at least one processor is further configured to generate a random number and use the generated random number in the first generated codeword.

21. The first computing device of claim 16, wherein the first computing device is one of a smartphone, a smartwatch, a tablet device, a desktop computer, or a laptop computer.

22. The first computing device of claim 16, wherein the wireless network is a direct device-to-device mesh network that the first computing device automatically joins the direct device-to-device mesh network in response to detecting the direct device-to-device mesh network.

23. The first computing device of claim 22, wherein the wireless network comprises one of a Wi-Fi network, a ZigBEE network, or a Bluetooth network.

24. A second computing device, comprising:
a memory;
a display
a transceiver configured to communicate with a first computing device via a wireless network; and
a processing system coupled to the memory and the transceiver, wherein at least one processor of the processing system is configured to:
receive a passcode reset request from the first computing device, the passcode reset request including a first generated codeword;
receive a user input of a first received codeword;
transmit to the first computing device a passcode reset response via the wireless network, the passcode reset response including the first received codeword;
receive an authentication success message from the first computing device;
generate a second codeword in response to receiving the authentication success message from the first computing device;
display the second generated codeword on the display;
receive a passcode reset confirmation from the first computing device via the wireless network, the passcode reset confirmation including a second received codeword;
determine whether the second generated codeword matches the second received codeword included in the passcode reset confirmation; and
transmit an authentication pairing success message to the first computing device in response to determining that the second generated codeword matches the second codeword included in the passcode reset confirmation.

25. The second computing device of claim 24, wherein the at least one processor is further configured to:
configure the transceiver to communicate with the first computing device via the wireless network; and
connect the second computing device to the wireless network.

26. The second computing device of claim 24, wherein the at least one processor is further configured to:
receive configuration data by the second computing device;
identify the wireless network using the configuration data;
identify the first computing device using the configuration data;
connect to the wireless network; and
communicate with the first computing device for pairing.

27. The second computing device of claim 24, wherein the at least one processor is further configured to generate the second codeword as a randomly generated number.

28. The second computing device of claim 24, wherein the second computing device is one of a smartphone, a smartwatch, a tablet device, a desktop computer, or a laptop computer.

29. The second computing device of claim 24, wherein:
the wireless network is a wireless direct device-to-device mesh network; and
the at least one processor of the processing system is further configured to automatically join the wireless direct device-to-device mesh network in response to detecting the wireless direct device-to-device mesh network.

30. The second computing device of claim 29, wherein the wireless network comprises one of a Wi-Fi network, a ZigBEE network, or a Bluetooth network.
